(19) United States
(12) Patent Application Publication
(10) Pub. No.: US 2001/0046454 A1
(43) Pub. Date: Nov. 29, 2001

(54) Well chamber holder

(75) Inventors: Diego Fontayne, Montebello, NY (US); Daniel Ueda, Cliffside Park, NJ (US)

Correspondence Address: FOLEY & LARDNER, Washington Harbour, Suite 500, 3000 K Street, N.W., Washington, DC, 20007-5109, US

(73) Assignee: INTEGRATED IMPLANT SYSTEMS, L.L.C.

(21) Appl. No.: 09/858,496

(22) Filed: May 17, 2001

Related U.S. Application Data
(60) Provisional application No. 60/205,298, filed on May 19, 2000.

(51) Int. Cl. B01L 3/14

(52) U.S. Cl. 422/102; 436/57

(57) ABSTRACT

A well chamber holder includes a first tube and a second tube. The first tube is capable of being rotated by way of a first knob, and the second tube is capable of being rotated by away of a second knob. The first and second tubes are be positioned such that only one particular seed of a seed cartridge placed within the well chamber holder is tested at any one time.

### BACKGROUND OF THE INVENTION

1. Field of the Invention

The present invention relates to a well chamber hold that is used to perform verification and/or calibration tests for seed cartridges.

2. Description of the Related Art

For treating prostate cancer, radioactive seeds are provided to various locations within a patient's prostate gland. These seeds are provided by a seed implantation instrument. Before the seeds can be used to treat a patient, they should be verified to assure that the seeds are of sufficient dosage to accurately treat the patient.

One way to test seeds is to use a device that has two metal plates, with fluid, such as water, provided between the two plates. A voltage V is applied across the plates, in order to get a potential. Probes are provided on the bottom and on the top of the device. A radioactive source, such as a seed, is placed into the middle of the device. The radiation causes photons to move along a path, and to pass through the fluid and ionizes the fluid, and creates a voltage. This causes current to flow, which is detected by a current meter.

Based on the amount of current detected, a radioactive strength of the seed can be determined.

Another way to test seeds in the field is to use a barrel-like structure. The structure includes a holder that has two disks, held together by three rods. In the center is a steel tube, with is separated with a plastic tube, and which is reattached with another steel tube on the other side of the plastic tube. With this structure, one seed is fitted into the hole, whereby it falls into the opening due to gravity. Radiation comes out radially from the area where the plastic tube is, when the seed falls through that area of the steel tube. One can then measure the radioactive strength of that one seed. This process is repeated for each seed to be tested.

Another conventional way to test seeds is to provide an array of seeds lined up in a cartridge, say 20 seeds. With such a configuration, a shield is removed from the array of seeds, thereby providing a radiation exposure of the seeds. One can then take a measurement to get an average radioactivity value for each seed.

The problem with such a method is that if one seed is too strong and one seed is too weak, one may get an “acceptable” average value, which is an incorrect determination, since at least two of the seeds in the group are “defective”. The problem with the other earlier-described methods is that they are cumbersome and do not provide an easy way to test a group of seeds.

Also, none of these methods are useful for testing seeds loaded within a seed cartridge.

### SUMMARY OF THE INVENTION

One object of the present invention is to provide a device that is capable testing seeds within a cartridge, one seed at a time, in order to accurately determine whether each seed is acceptable or not.

### BRIEF DESCRIPTION OF THE DRAWINGS

The invention will become more fully apparent from the following detailed description when read in conjunction with the accompanying drawings with like reference numerals indicating corresponding parts throughout, and wherein:

FIG. 1 shows a unit in which a well chamber holder can be set within, to perform verification or calibration tests, in accordance with the present invention;

FIG. 2 shows a cross-sectional view of the structure of FIG. 1, where the cross-sectional view does not go through the cartridge;

FIG. 3 shows a cross-sectional view of the structure of FIG. 1, where the cross-sectional view does go through the cartridge;

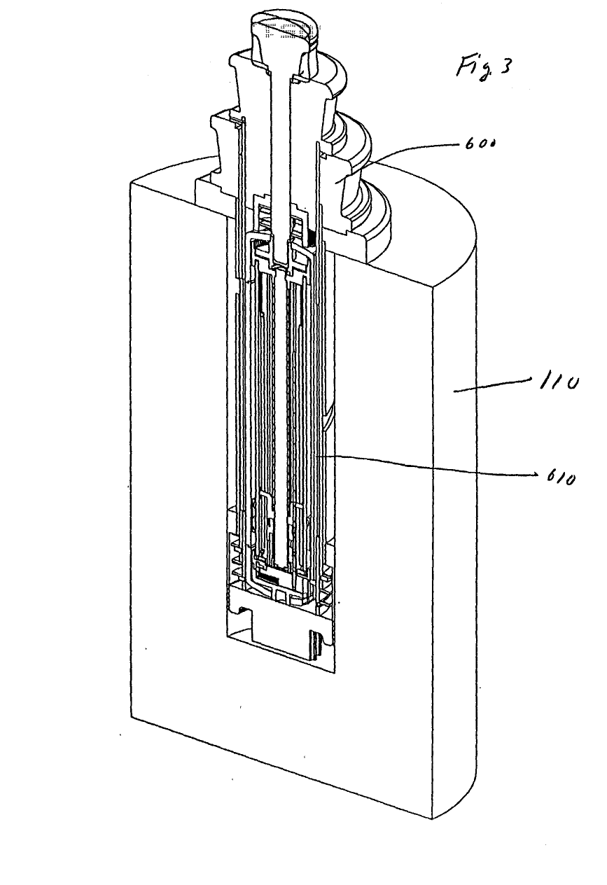

FIG. 4 shows the outer housing of the well chamber holder, in accordance with the present invention;

FIG. 5 shows the structure of FIG. 4, but with an element removed for sake of clarity, in accordance with the present invention;

FIG. 6 shows various elements of the well chamber holder, as well as an element that is fitted into the holder and an element in which the holder is fitted into, where these elements are shown separated from each other for sake of clarity, in accordance with the present invention;

FIG. 7 shows various elements of the well chamber holder, where these elements are shown separated from each other for sake of clarity, in accordance with the present invention;

FIG. 8 shows different view of the exterior of the well chamber holder, in accordance with the present invention;

FIG. 9 two cross-sectional views of the well chamber holder, in accordance with the present invention;

FIG. 10 shows a knob of the well chamber holder, in accordance with the present invention;

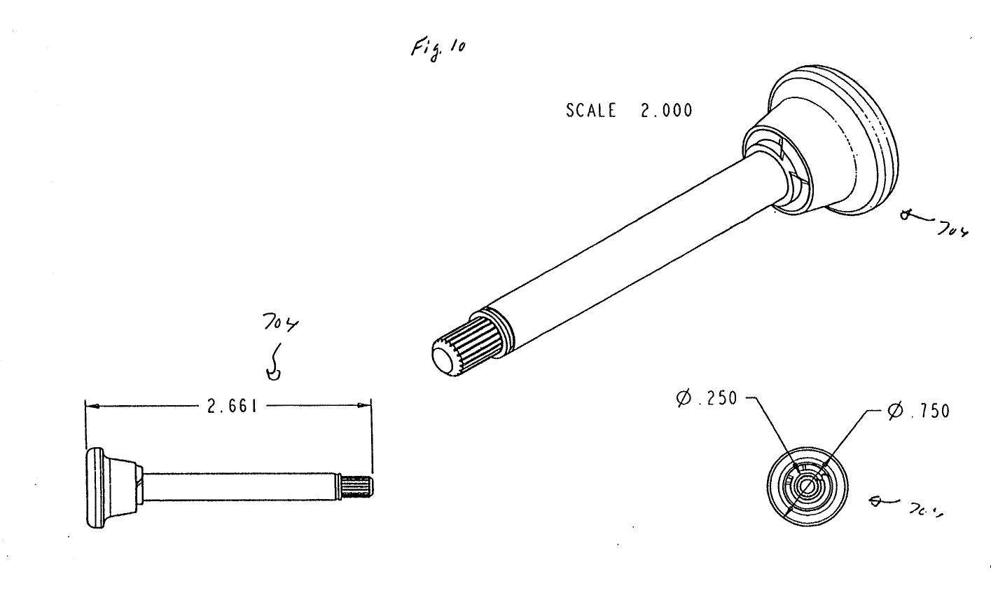

FIG. 11 shows a tool used to set the cartridge in a precise position within the well chamber holder, in accordance with the present invention;

FIG. 12 shows a cap cartridge holder, in accordance with the present invention;

FIG. 13 shows a tube-cap holder, in accordance with the present invention;

FIG. 14 shows an altitude ring-holder, in accordance with the present invention;

FIG. 15 shows a base ring-holder, in accordance with the present invention;

FIG. 16 shows a conduit ring-holder, in accordance with the present invention;

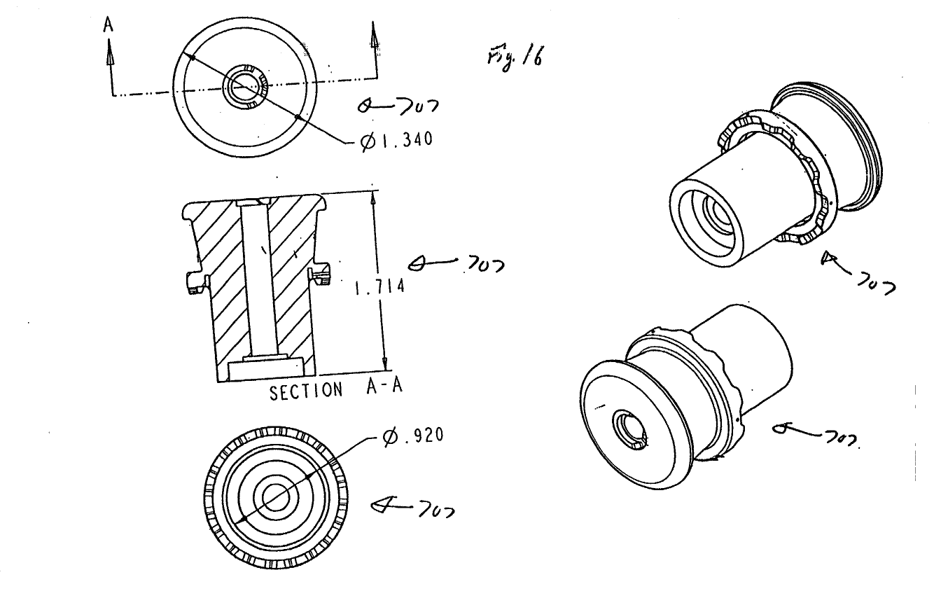

FIG. 17 shows a retainer ring that can be used in the well chamber holder, in accordance with the present invention;

FIG. 18 shows an altitude-tube, in accordance with the present invention;

FIG. 19 shows a base-tube, in accordance with the present invention;

FIG. 20 shows a conduit tube, in accordance with the present invention;

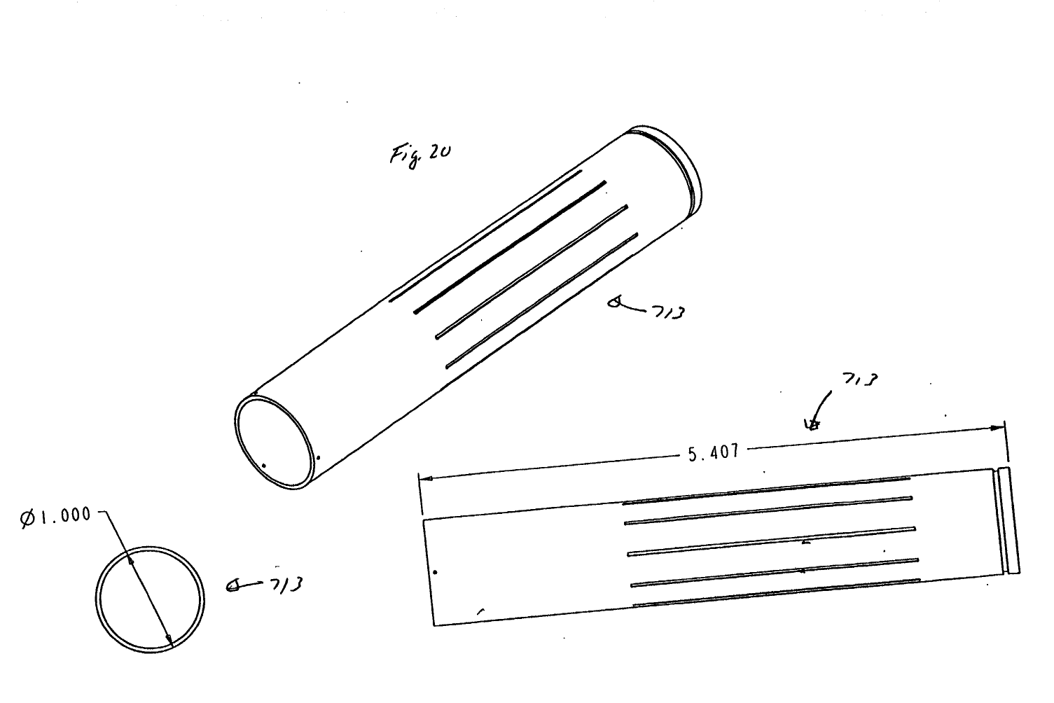

FIG. 21 shows washers that may be utilized within the well chamber holder, in accordance with the present invention; and

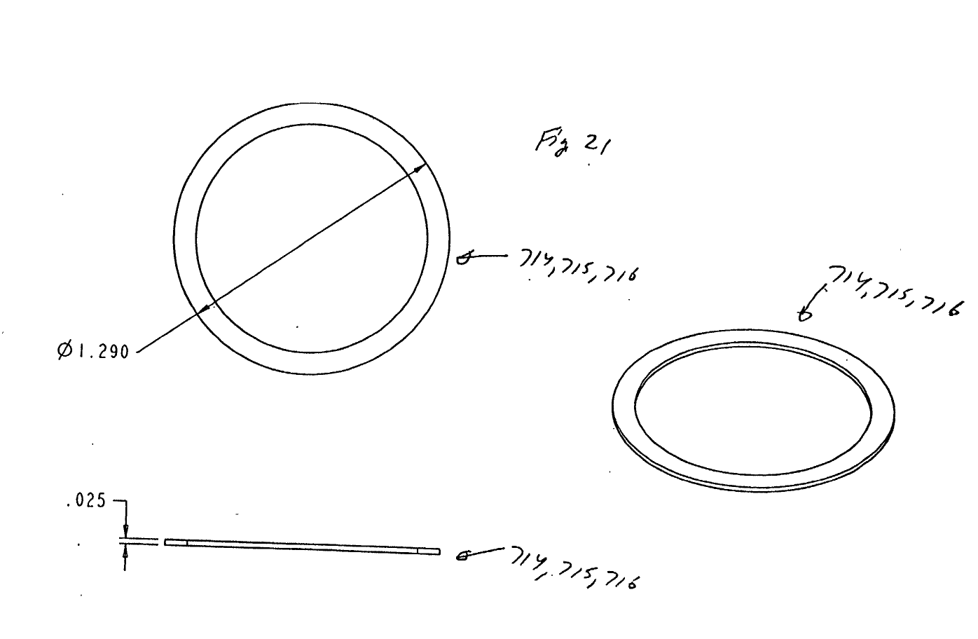

FIG. 22 shows a wave washer that may be utilized within the well chamber holder, in accordance with the present invention.

### DETAILED DESCRIPTION OF THE PREFERRED EMBODIMENT

A preferred embodiment of the present invention will be described in detail hereinbelow, with reference to the drawings

The present invention is directed to well chamber holder that is configured to accept a seed cartridge, and to provide a mechanism for a user to test each of the seeds within that seed cartridge.

Details of a seed cartridge that can be fitted into a seed implantation medical instrument is a subject of a first related application entitled “CART RIDGE-MOVEABLE SHIELD”, Foley & Lardner Attorney Docket No. 058574/0121, which is incorporated in its entirety herein by reference. Details of a seed implantation medical instrument that can accept a seed cartridge, is a subject of a second related application entitled “MEDICAL INSTRUMENT”, Foley & Lardner Attorney Docket No. 058574/10126, which is incorporated in its entirety herein by reference.

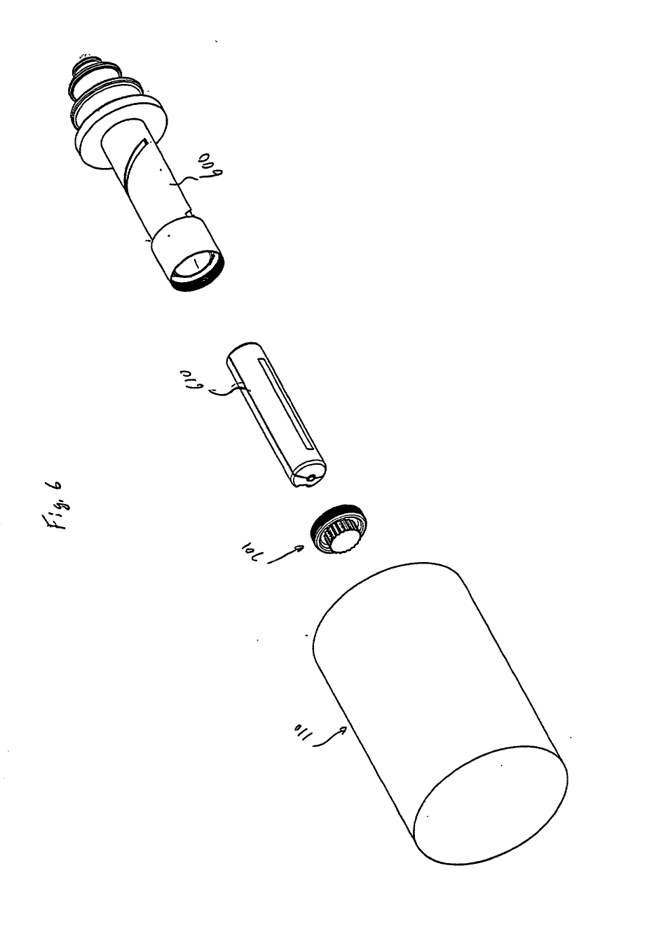

According to the present invention, a seed cartridge 610 is inserted into a bottom portion of a well chamber holder 600, as seen in FIG. 6. The well chamber holder 600 and the seed cartridge 610 are constructed so that the seed cartridge 610 can only be oriented in one position with respect to the well chamber holder 600. In more detail, an oval-slot is provided on the outer housing of the seed cartridge 610, which is fitted onto an oppositely-shaped protrusion on the inner surface of the well chamber holder 600.

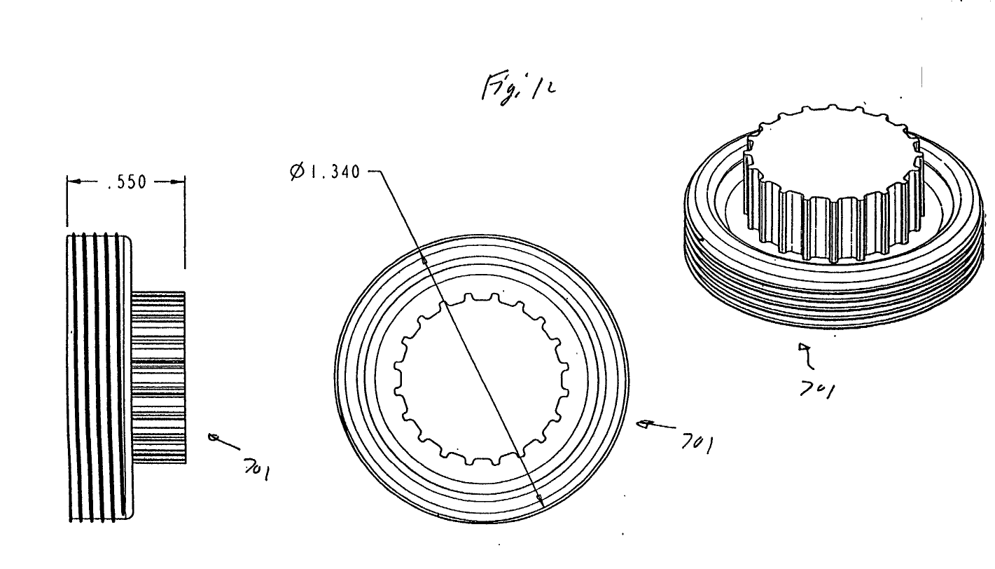

Once the seed cartridge 610 has been fitted into the well chamber holder 600, a cap 701, as shown in FIG. 12, is screwed onto the bottom end of the well chamber holder 600, to thereby secure the seed cartridge 610 within the well chamber holder 600.

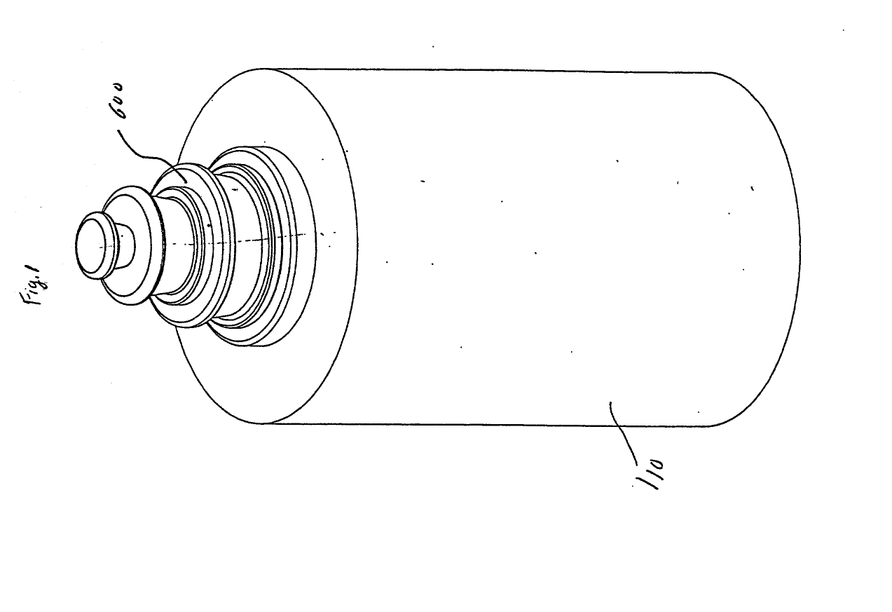

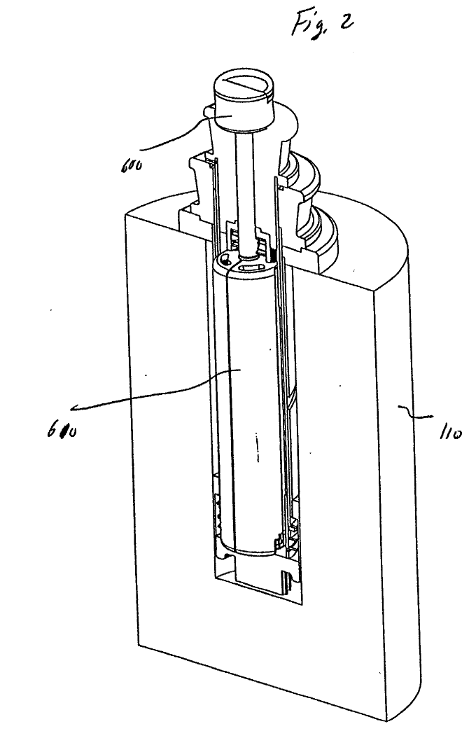

FIGS. 1 and 2 show a unit 110 in which the well chamber holder 600 is placed into. The unit 110 is preferably made of plastic, or some other kind of material that does not attenuate radiation energy.

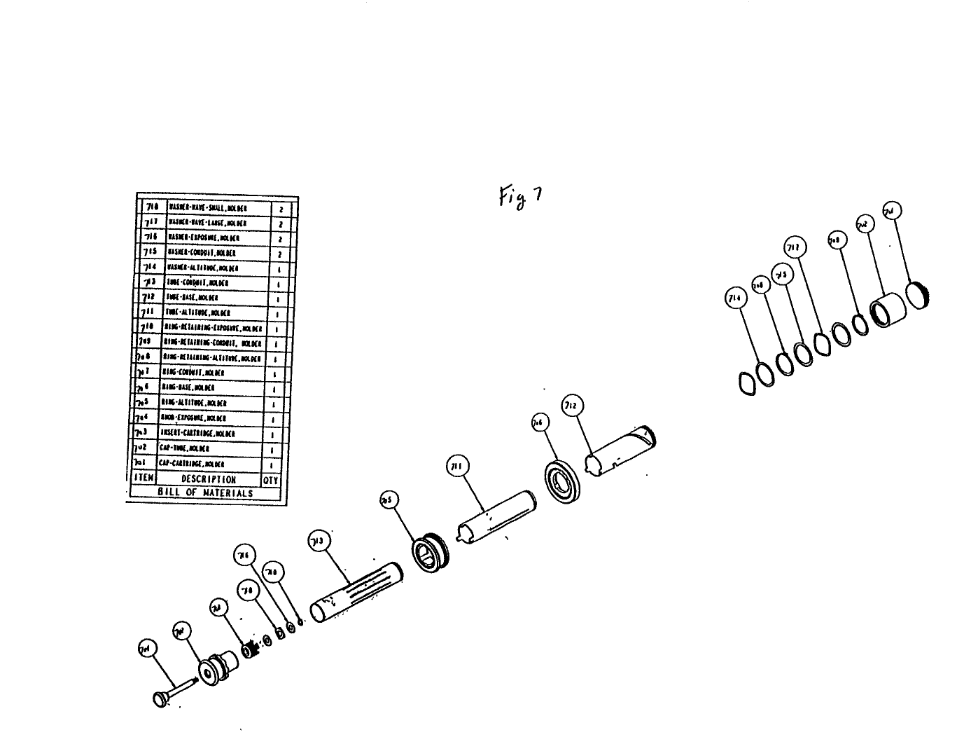

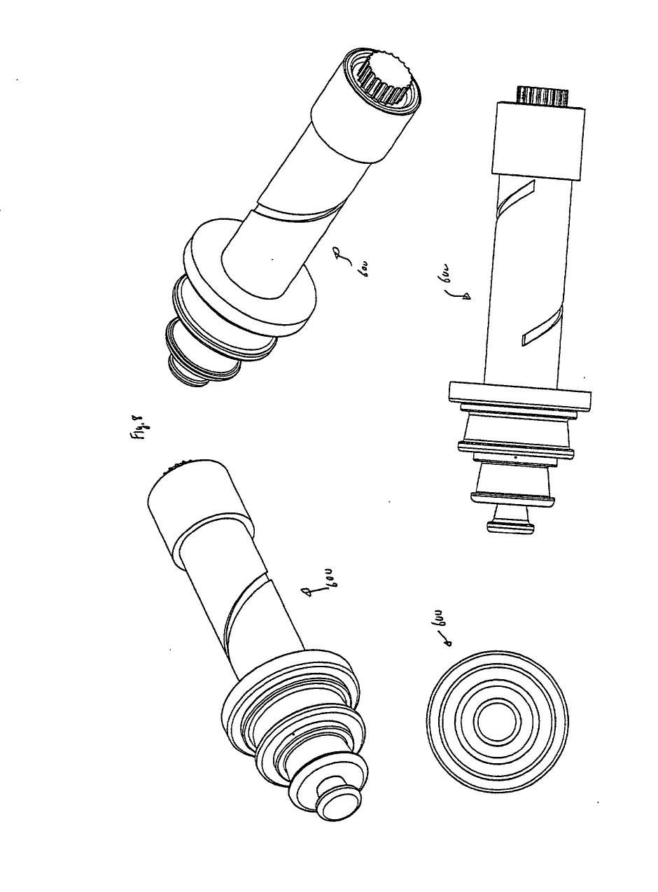

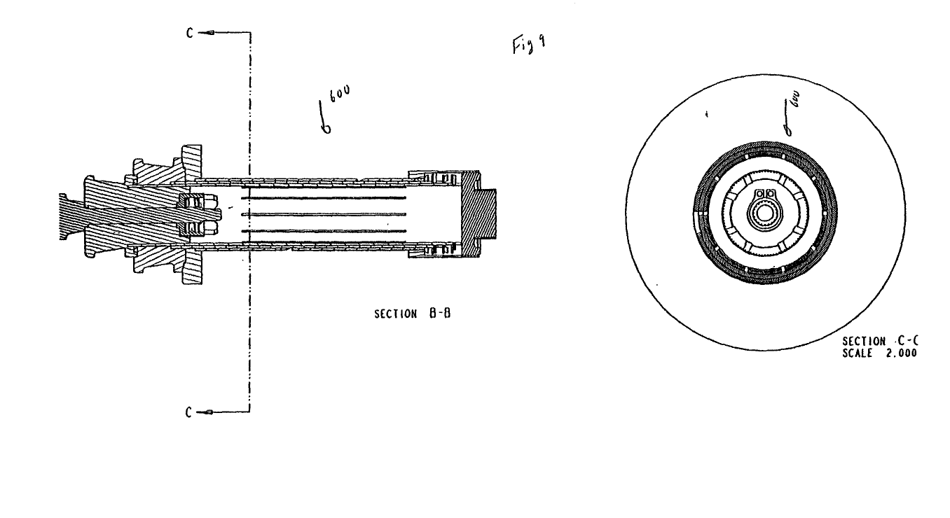

FIG. 7 shows the various elements making up the well chamber holder 600, and FIG. 8 shows different views of the well chamber holder 600, and FIGS. 9A and 9B show two different cross-sectional views of the well chamber holder 600.

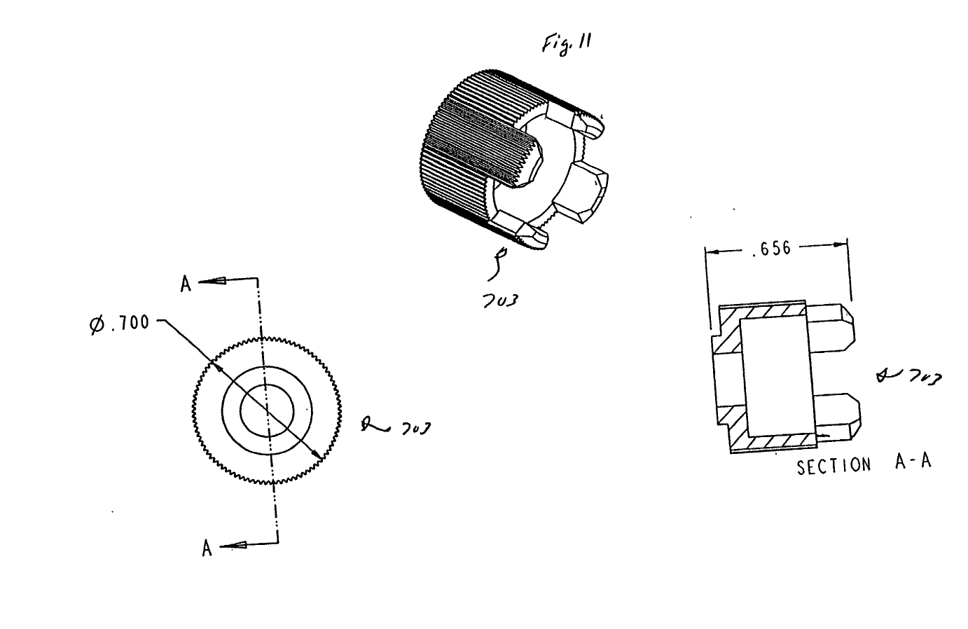

Once the cartridge is put in the correct position within the well chamber holder 600, the four openings on the proximal end of the cartridge 610 are received by a tool 703, as seen in FIG. 11. The tool 703 holds the cartridge 610 in a precise position within the well chamber holder 600, and removes any possible minor shifting of the cartridge 610 within the well chamber holder 600.

Referring now to FIG. 7, the well chamber holder 600 includes a conduit (or “inner”) tube 713, a conduit ring-holder 707, an altitude (or “middle”) tube 711, an altitude ring-holder 705, a base (or “outer”) tube 712, and a base ring-holder 706. The altitude tube 711 and the base tube 712 each has a respective retaining ring 709, 708 associated with it.

The conduit tube 713 has slots, which are in exact alignment with the cartridge 610 when the cartridge 610 is rotated to the calibration position by way of the knob 704. In more detail, the knob 704 is biased downwards, so that it always wants to rest against the conduit ring 707 disposed directly below it. When a user pulls upwards on the knob 704, the splines remain within the teeth of the adaptor of the cartridge 610. With the knob 704 held in a upwards position, it is capable of being rotated to a position 18 degrees apart from its initial position. The knob 704 can then be released, whereby the cartridge 610 has been set to the calibration mode by this action, due to the splines on the distal end of the knob 704 rotating the adaptor of the cartridge eighteen degrees to align the slots of the inner shield (“shield barrel”) of the cartridge 610 with the slots of the outer shield (“tube-scale”) of the cartridge 610.

The rings of the well chamber holder 600 are used to provide an opening to test one seed at a time within the cartridge 610. The altitude tube 711 has a single slot that can be lined up with one of the slots of the cartridge 610, thereby allowing radiation energy from the (up to) fifteen seeds in the corresponding seed conduit of the cartridge 610 below that slot to emanate exterior to the altitude tube 711. The base tube 712 has a helical slot provided thereon, and is used to isolate one seed of the fifteen seeds of a seed conduit that is exposed by way of the altitude tube 711. That is, the combination of the altitude tube 711 and the base tube 712 allows for radiation energy from one seed within the cartridge to be emanated to the exterior. That energy passes through the rest of the elements, whereby that energy can be measured to determine if that seed is viable.

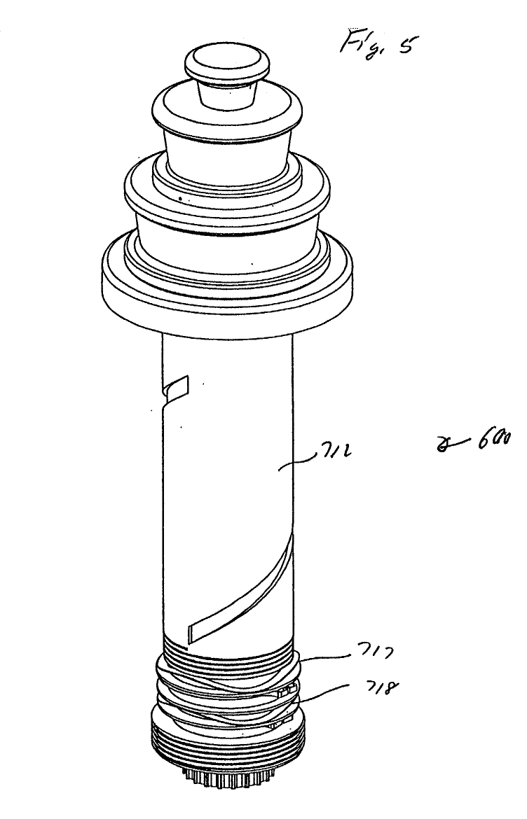

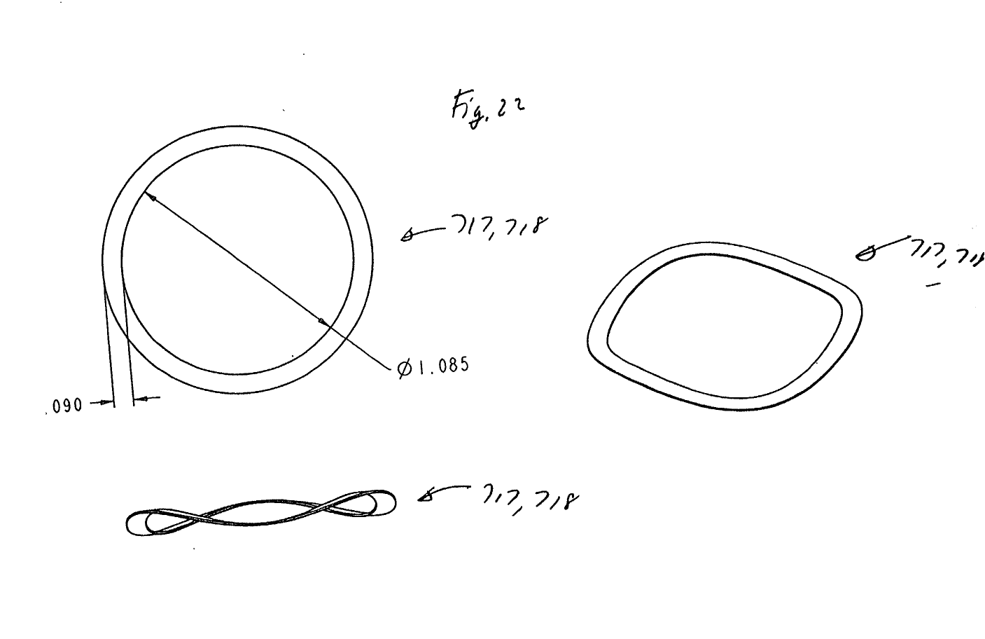

FIG. 5 shows wave washers 717, 718 provided at the bottom of each tube, where they provide tension even when their respective ring-holder is pushed up. The ring-holders are each biased so that they always want to return to the closed (“down”) position. The wave washers 717, 718 are shown in detail in FIG. 22.

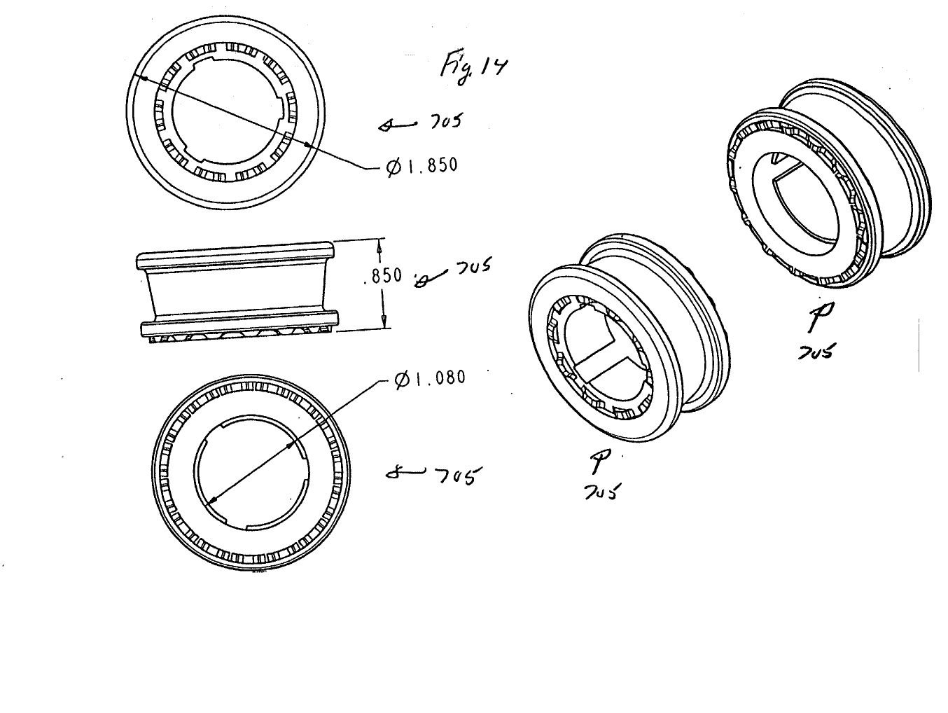

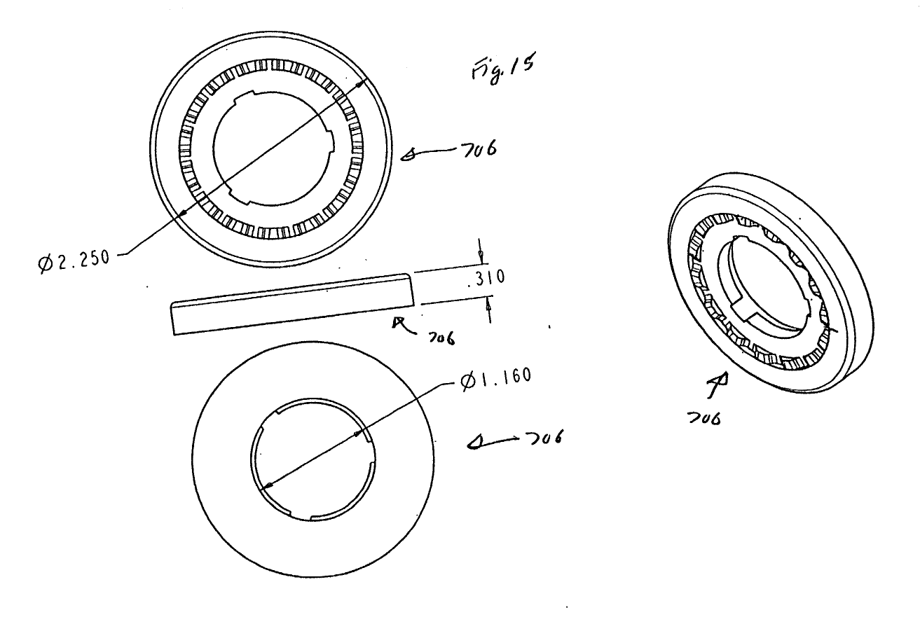

FIG. 15 shows the base ring-holder 706 in detail. The base ring-holder 706 provides for fifteen different positions that it can be set to, and these correspond to the fifteen different positions that a seed can line up in any one seed conduit. With the knob 4 placed in the position corresponding to the verification or calibration mode, the base ring-holder 706 can be pulled upwards and placed into any of the fifteen possible positions. With the base ring-holder 706 pulled up, the altitude ring-holder 705, as seen in FIG. 14 in detail, can be placed into any of the ten different positions that it is allowed to be set to. These ten positions correspond to one of the ten slots of lined-up shield barrel and tube-scale of the cartridge 610. With the desired setting in place, the operator can then release the rings, where they are biased back down to their proper positions. Testing can be performed by measuring the radiation energy emitted by the one seed that is allowed to radiate to the exterior of the well chamber holder 600. Numeric indicators are provided on the ring-holders to allow an operator to determine the precise seed position to be tested.

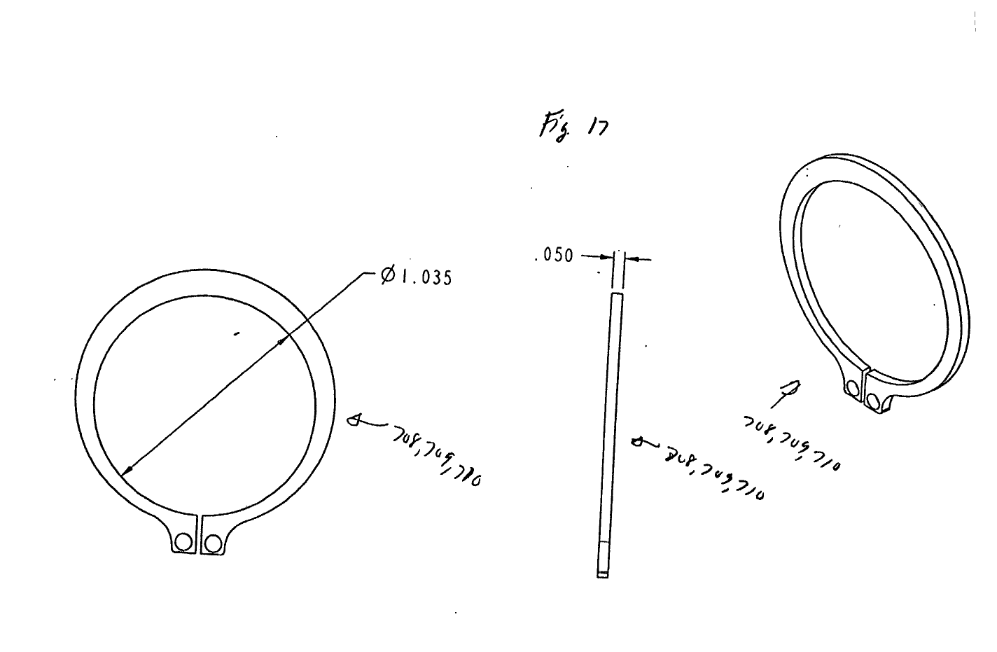

The retainer rings 708, 709, 710 (see FIG. 17) hold the tubes snugly against their respective ring-holders, so that when the ring-holders are rotated by a certain amount, the tubes are rotated by that same amount.

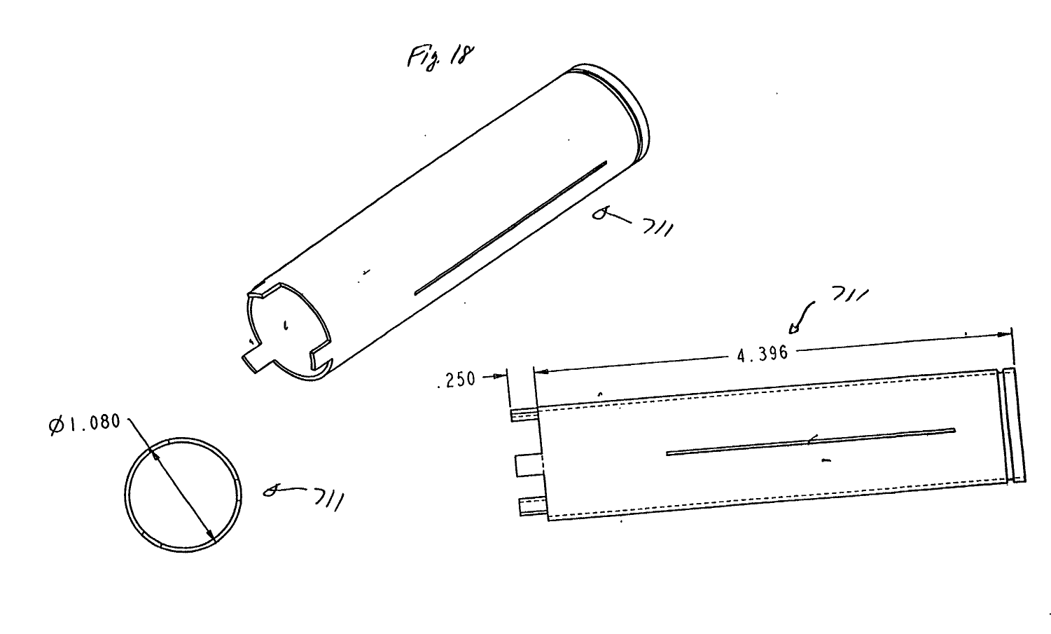

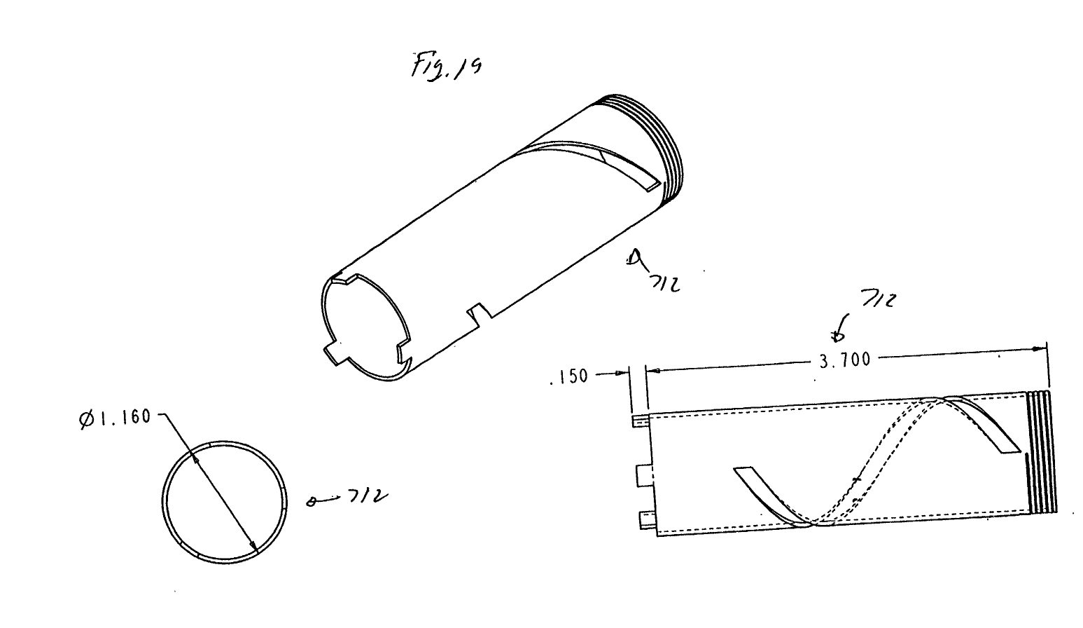

FIGS. 18 and 19 show different views of the base tube and the altitude tube, whereby each tube has three tabs at one end, which are received and held in place at corresponding slots of their respective ring-holders. See FIGS. 14 and 15 that show the three slots on the altitude ring-holder and the base ring-holder that accept the three tabs of the respective tube.

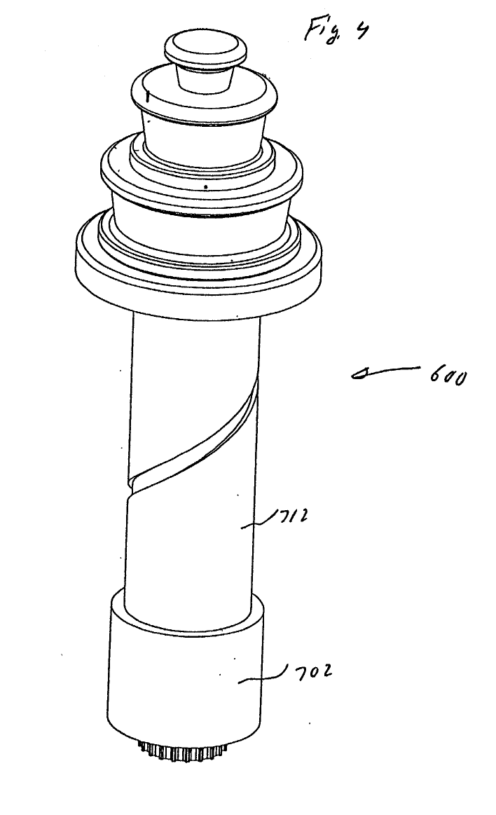

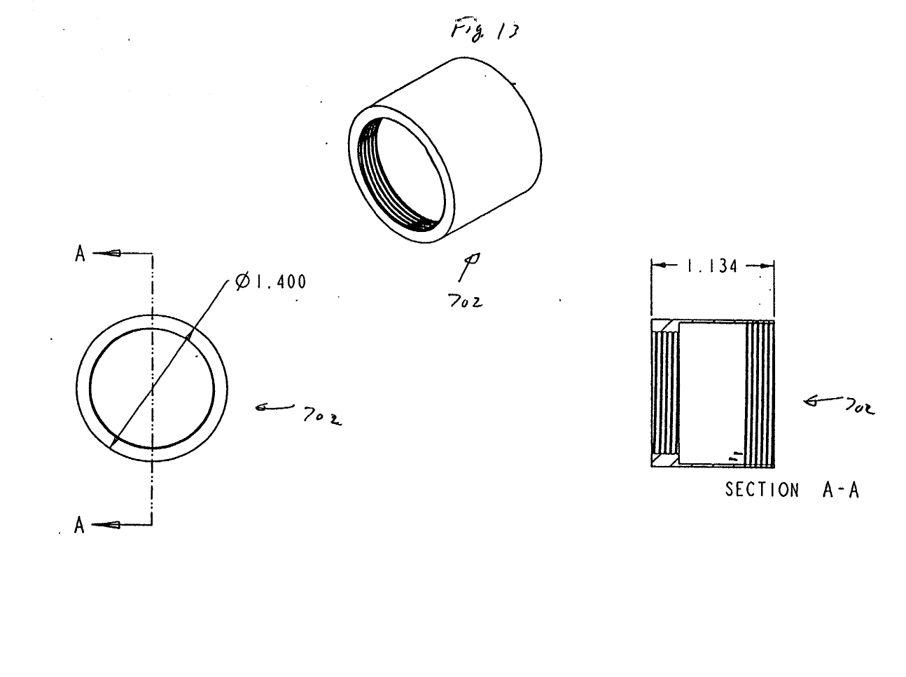

FIG. 13 shows a tube-cap holder 702, which is screwed onto one end of the base tube. See FIG. 4 which shows the tube-cap holder 702 screwed onto the base tube 712. The cap-cartridge holder 701 screws onto the tube-cap holder 702, to provide a tight fit. These elements are preferably stainless-steel parts, so that little if any attenuation will pass through them.

While the above components are described with respect to the preferred embodiment, other similar types of components may be utilized, while remaining within the spirit and scope of the present invention, as exemplified by the claims.

What is claimed is:

1. A well chamber holder, comprising:
a first tube that has a first slot for allowing radiation energy to pass therethrough; and
a second tube that has a second slot for allowing radiation energy to pass therethrough,
wherein the first and second tubes are capable of being manipulated so that only one seed position of a seed cartridge disposed in an interior region with respect to the first and second tubes radiates to an exterior of the well chamber holder.
